(19) United States
(12) Patent Application Publication
(10) Pub. No.: US 2018/0307785 A1
(43) Pub. Date: Oct. 25, 2018

(54) MAGNETIC MATERIAL SIMULATION PROGRAM, MAGNETIC MATERIAL SIMULATION APPARATUS, AND MAGNETIC MATERIAL SIMULATION METHOD

(71) Applicant: FUJITSU LIMITED, Kawasaki-shi (JP)

(72) Inventors: Tadashi Ataka, Kawasaki (JP); Atsushi Furuya, Yokohama (JP)

(73) Assignee: FUJITSU LIMITED, Kawasaki-shi (JP)

(21) Appl. No.: 15/944,405

(22) Filed: Apr. 3, 2018

(30) Foreign Application Priority Data
Apr. 19, 2017 (JP) 2017-083117

(51) Int. Cl. G06F 17/50; G06F 17/16

(52) U.S. Cl. CPC G06F 17/5009; G06F 17/12; G06F 17/5018; G06F 17/16

(57) ABSTRACT

A magnetic material simulation method for a computer to execute a process including: calculating, from first magnetization vector information at first time on elements obtained by dividing a magnetic substance into a plurality of meshes, first static magnetic field potential information of the elements at the first time; calculating a magnetization vector calculation matrix A which is based on interaction between the meshes at second time, by using the first magnetization vector information and the first static magnetic field potential information; calculating a magnetization vector calculation matrix B which is based on interaction between the meshes at the first time, by using the first magnetization vector information and the first static magnetic field potential information; and calculating second magnetization vector information on the elements at the second time, by using the first magnetization vector information, the first static magnetic field potential information, the matrix A, and the matrix B.

### CROSS-REFERENCE TO RELATED APPLICATION

This application is based upon and claims the benefit of priority of the prior Japanese Patent Application No. 2017-83117, filed on Apr. 19, 2017, the entire contents of which are incorporated herein by reference.

### FIELD

The embodiments discussed herein are related to a magnetic material simulation program, magnetic material simulation apparatus, and magnetic material simulation method.

### BACKGROUND

As a technique for analyzing magnetization behavior of a magnetic substance, there has been known micro magnetic simulation (hereinafter referred to as the “MS”) which models a magnetic substance as a collection of small magnets and numerically simulates the magnetic domain state. The micro magnetic simulation is used for analyzing magnetic domain states of micro magnetic devices, such as magnetic heads of hard disc drives (HDD) and magnetoresistive random access memories (MRAM), as well as magnetic materials, such as permanent magnets and electromagnetic steel plates. The following techniques are examples of techniques related to the micro magnetic simulation.

A first technique is a technique for improving calculation accuracy in the micro magnetic simulation. In an aspect of the first technique, a magnetization analysis apparatus includes an intermediate magnetization calculator, effective magnetic field calculator, and magnetization calculator. The intermediate magnetization calculator uses the magnetization vectors of each and its adjacent elements out of the elements obtained by mesh division, in which a magnetic substance is divided into multiple meshes to calculate the intermediate magnetization which is the magnetization vector at the intermediate point between the two adjacent elements. The effective magnetic field calculator uses the intermediate magnetization calculated by the intermediate magnetization calculator to calculate the effective magnetic field. The magnetization calculator calculates the magnetization vector of each element after every unit time, based on the effective magnetic field calculated by the effective magnetic field calculator.

A second technique is a technique capable of calculating the magnetic exchange coupling magnetic field with high accuracy even in the case where the rotation angle of the magnetization vector is large. In the second technique, a magnetic exchange coupling energy calculation apparatus includes an interpolation unit for interpolation and a calculation unit. The interpolation unit interpolates the rotation angle between two magnetization vectors which are used in the finite volume method and located at the centers of elements adjacent to each other, based on the rotation axis orthogonal to the two magnetization vectors. The calculation unit integrates the magnetic field, which acts as force applied to the two magnetization vectors, with respect to the interpolated rotation angle to calculate the magnetic exchange coupling magnetic field.

Techniques related to the first technique described above are disclosed in, for example, Japanese Laid-open Patent Publication No. 2016-42216 and C. J. Garcia-Cervera, “Numerical Micromagnetics: A Review”, Bol. Soc. Esp. Mat. Apl., 2007 1-33. Techniques related to the second technique described above are disclosed in, for example, Japanese Laid-open Patent Publication No. 2012-33116 and also in the above document by C. J. Garcia-Cervera.

An object of this disclosure in one aspect is to improve the calculation speed of the micro magnetic simulation.

### SUMMARY

According to an aspect of the invention, a magnetic material simulation method for a computer to execute a process, the process including: calculating, from first magnetization vector information at a first time on elements obtained by dividing a magnetic substance into a plurality of meshes, first static magnetic field potential information of the elements at the first time; calculating a magnetization vector calculation matrix A which is based on interaction between the meshes at a second time, by using the first magnetization vector information and the first static magnetic field potential information; calculating a magnetization vector calculation matrix B which is based on interaction between the meshes at the first time, by using the first magnetization vector information and the first static magnetic field potential information; and calculating second magnetization vector information on the elements at the second time, by using the first magnetization vector information, the first static magnetic field potential information, the magnetization vector calculation matrix A, and the magnetization vector calculation matrix B.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a magnetic substance divided into micromagnetization segments;

FIG. 2 illustrates an example of a magnetic material simulation apparatus according to the present embodiment;

FIG. 3 illustrates an example of the hardware configuration of the magnetic material simulation apparatus;

FIG. 4 is an example of a flowchart of simulation processing in the present embodiment;

FIG. 5 is an example of a flowchart of the simulation processing;

FIG. 6 is an example of a detailed processing procedure of update processing for magnetization vector data at S312 in FIG. 5;

FIG. 7 is a timing chart illustrating data update timings in the first embodiment;

FIGS. 8A, 8B, and 8C are examples of data used in the first embodiment;

FIG. 9 is a diagram for explaining a method of creating components related to the SST term of a matrix A;

FIG. 10 is a flowchart of time integration calculation for obtaining the oscillation frequency of the spin torque oscillator (STO) in the first embodiment;

FIG. 11 is an example of a flowchart of simulation processing in the second embodiment;

FIG. 12 is an example of detailed processing procedure for updating static magnetic field potentials and magnetization vector data in two steps at S32 in FIG. 11;

FIG. 13 is a timing chart illustrating data update timings in the second embodiment;

FIG. 14 is a flowchart of time integration calculation for obtaining the oscillation frequency of the spin torque oscillator (STO) in the second embodiment; and

FIG. 15 is a table for confirming the increase in speed of calculation for obtaining the oscillation frequency of the STO in the second embodiment.

### DESCRIPTION OF EMBODIMENTS

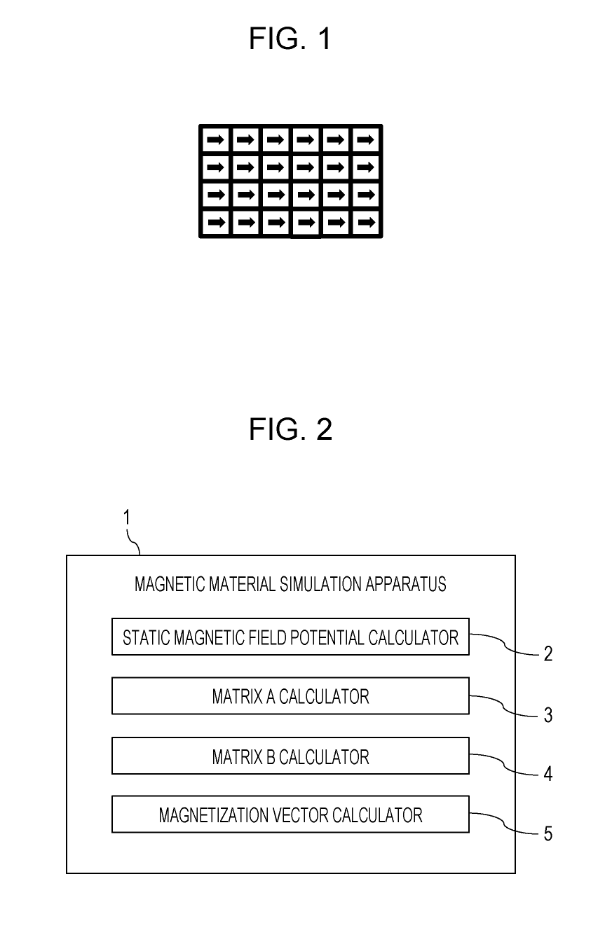

FIG. 1 is a schematic diagram of a magnetic substance divided into micromagnetization segments. The MS is a method used for theoretical calculation of a magnetic substance. In the method, as illustrated in FIG. 1, a magnetic substance is divided into microscopic elements, in each of which a micromagnetization is arranged to calculate the behavior of each micromagnetization.

In the MS, the movement of each micromagnetization is described by the following differential equation (LLG equation).

$$\begin{matrix}\frac{\partial \vec{m}}{\partial t} = - \frac{γ}{1 + {α}^{2}} ( \vec{m} \times {\vec{H}}_{eff} ) - \frac{αγ}{1 + {α}^{2}} ( \vec{m} \times \vec{m} \times {\vec{H}}_{eff} ) & ( 1 ) \\ {\vec{H}}_{eff} = - \frac{1}{{M}_{s}} \frac{δ}{δ \vec{m}} [ {E}_{ani} + {E}_{exc} + {E}_{app} + {E}_{d} ] & ( 2 )\end{matrix}$$

where \vec{m}: normalized magnetization vector, γ: gyromagnetic constant [S⁻¹T⁻¹], α: damping constant, M_{S}: saturation magnetization [T], Eₐₙᵢ: anisotropic energy [J], E_{exc}: exchange coupling energy [J], Eₐₚₚ: Zeeman energy [J], and E_{d}: static magnetic field energy [J].

Here, the symbol “→” indicates that it is a vector. Hereinafter, the symbol “→” indicating a vector is used only in expressions, and omitted in other parts. The symbol “×” indicates a cross product.

Each energy is expressed as follows.

Eₐₙᵢ=∫dVKᵤ(1−(\vec{k}·\vec{m})²) (3)

E_{exc}=∫dVA(∇\vec{m})² (4)

Eₐₚₚ=−∫dVMₛ\vec{H}ₐₚₚ·\vec{m} (5)

E_{d}=−½∫dVMₛ\vec{H}_{d}·\vec{m} (6)

\vec{H}_{d}=−∇ϕ (7)

Δϕ=∇·\vec{m} (8)
where \vec{k}: magnetic anisotropy vector, Kᵤ: magnetic anisotropy constant [J/m³], A: exchange coupling constant [J/m], \vec{H}ₐₚₚ: external magnetic field [A/m], φ: static magnetic field potential [A], and \vec{H}_{d}: static magnetic field vector [A/m].

When electric current flows through the magnetic substance, transfer of spin angular momentum occurs in the magnetic substance, and a torque acts on the magnetic substance. This effect is generally called the spin transfer effect (hereinafter referred to as the “ST effect”). In addition, torque which acts on the magnetic substance is called spin transfer torque (hereinafter referred to as “STT”). The ST effect is not considered in Expression (1). To handle the ST effect in the MS, the STT is converted into a magnetic field equivalent to the STT thereof to correct the right side of Expression (1). Hereinafter, the LLG equation in which the ST effect is considered is referred to as the “S-LLG equation”. Depending on systems using magnetic substances, various forms have been proposed for the ST effect, and the form of the magnetic field after conversion is different for each system.

For example, the LLG equation in which the STT of the spin injection type (the S-LLG equation of the spin injection type) is considered is expressed with the following expressions.

$$\begin{matrix}\frac{\partial \vec{m}}{\partial t} = - \frac{γ}{1 + {α}^{2}} [ \{ \vec{m} \times ( {\vec{H}}_{eff} + {H}_{s} ( α + β ) \vec{p} ) \} - \{ \vec{m} \times \vec{m} \times ( α {\vec{H}}_{eff} - {H}_{s} ( 1 - αβ ) \vec{p} ) \} ] & ( 9 ) \\ {H}_{s} = \frac{{p}_{0} ℏ}{2 {eM}_{s} δ \{ 1 - λ ( \vec{m} \cdot \vec{p} ) \}} \vec{J} & ( 10 )\end{matrix}$$

where \vec{p}: normalized adjacent magnetization vector, β: field-like torque, p₀: electron polarization factor, ℏ: Planck's constant, J: current density, e: elementary charge, δ: film thickness of magnetic substance, and λ: angle dependence coefficient.

The LLG equation in which the STT of the domain wall displacement type (the S-LLG equation of the domain wall displacement type) is considered is expressed with the following expressions.

$$\begin{matrix}\frac{\partial \vec{m}}{\partial t} = - \frac{1}{1 + {α}^{2}} [ γ \{ \vec{m} \times {\vec{H}}_{eff} \} - αγ \{ \vec{m} \times \vec{m} \times {\vec{H}}_{eff} \} - ( 1 - αβ ) \{ ( \vec{u} \cdot \overline{V} ) \vec{m} \} + β \{ m \times ( ( \vec{u} \cdot \overline{V} ) \vec{m} ) \} ] , & ( 11 ) \\ \vec{u} = {μ}_{0} \frac{{p}_{0} g {μ}_{B}}{2 {eM}_{s}} \vec{J} & ( 12 )\end{matrix}$$

where β: non-adiabatic coefficient, μ₀: vacuum permeability, g: g factor, and μ_{B}: Bohr magneton.

A characteristic of the S-LLG equation is that both Expressions (9) and (11) include nonlinear terms of the ST effect on the right sides.

The Crank-Nicholson method (hereinafter referred to as the “CN method”) has been proposed, in which the exchange coupling magnetic field is handled implicitly when solving the LLG equation with the MS (see C. J. Garcia-Cervera, “Numerical Micromagnetics: A Review”, Bol. Soc. Esp. Mat. Apl., 2007 1-33 (hereinafter referred to as “C. J. Garcia-Cervera”)). The CN method is a method for discretizing a differential equation. Compared to explicit methods, the CN method may use a large time step, and is expected to greatly reduce the number of calculations.

On the other hand, it is concerned that if the time step is large in the CN method, the calculation accuracy may deteriorate accordingly. Many of the studies on the CN method for the MS assume the LLG equation. Further, C. J. Garcia-Cervera 1 discusses only the precession term (the first term on the right side of Expression (1)) related to the exchange coupling term. A method including the entire LLG equation or an implementation method for a system in which a nonlinear term is further added, such as the S-LLG equation, have not been made clear.

When considering speeding up the MS, a larger time step using the CN method is expected to be very effective. However, when applying the CN method to analysis with the S-LLG equation, there are the following two problems.

(Problem 1) In the technique described in C. J. Garcia-Cervera, it is impossible for the CN method to be applied to the S-LLG equation.

(Problem 2) If the time step is large, the accuracy is low.

In light of the above, the present embodiment uses a method described below to solve the above two problems.

First, for the above (Problem 1), the static magnetic field is handled explicitly, and for the STT, part of the terms is partially handled implicitly. Concrete discrete equations are described in Expressions (13) and (14). Discretization here represents dividing calculation for each time step using k and k+1. The following describes a concrete discretization method. The superscript of each valuable in the expression indicates a step number.
A discretization method for applying the CN method to the S-LLG equation of the spin injection type

$$\frac{{\vec{m}}^{k + 1} - {\vec{m}}^{k}}{Δ t} = - γ \{ \frac{{\vec{m}}^{k + 1} \times ( {\vec{H}}_{ani}^{k} + {\vec{H}}_{exc}^{k} )}{2} + \frac{{\vec{m}}^{k} \times ( {\vec{H}}_{ani}^{k + 1} + {\vec{H}}_{exc}^{k + 1} )}{2} + \frac{{\vec{m}}^{k + 1} + {\vec{m}}^{k}}{2} \times ( {\vec{H}}_{d}^{k} + {\vec{H}}_{app}^{k} ) \} + α ( \frac{{\vec{m}}^{k + 1} + {\vec{m}}^{k}}{2} \times \frac{{\vec{m}}^{k + 1} - {\vec{m}}^{k}}{Δ t} ) - γ {H}_{s}^{k} [ ( \frac{{\vec{m}}^{k + 1} + {\vec{m}}^{k}}{2} ) \times ( {\vec{p}}^{k} \times {\vec{m}}^{k} ) ] - βγ {H}_{s}^{k} [ ( \frac{{\vec{m}}^{k + 1} + {\vec{m}}^{k}}{2} ) \times {\vec{p}}^{k} ] \qquad ( 13 )$$

A discretization method for applying the CN method to the S-LLG equation of the domain wall displacement type

$$\frac{{\vec{m}}^{k + 1} - {\vec{m}}^{k}}{Δ t} = - γ \{ \frac{{\vec{m}}^{k + 1} \times ( {\vec{H}}_{ani}^{k} + {\vec{H}}_{exc}^{k} )}{2} + \frac{{\vec{m}}^{k} \times ( {\vec{H}}_{ani}^{k + 1} + {\vec{H}}_{exc}^{k + 1} )}{2} + \frac{{\vec{m}}^{k + 1} + {\vec{m}}^{k}}{2} \times ( {\vec{H}}_{d}^{k} + {\vec{H}}_{app}^{k} ) \} + α ( \frac{{\vec{m}}^{k + 1} + {\vec{m}}^{k}}{2} \times \frac{{\vec{m}}^{k + 1} - {\vec{m}}^{k}}{Δ t} ) - ( {\vec{u}}^{′} \cdot \overline{V} ) \frac{{\vec{m}}^{k + 1} + {\vec{m}}^{k}}{2} + β [ {\vec{m}}^{k} \times ( {\vec{u}}^{k} \cdot \overline{V} ) \frac{{\vec{m}}^{k + 1} + {\vec{m}}^{k}}{2} ] \qquad ( 14 )$$

Hereinafter, descriptions are provided for the derivation of the S-LLG equation of the spin injection type illustrated in Expression (13). Expression (9) is derived from the S-LLG equation of the spin injection type illustrated in Expression (15).

$$\frac{\partial \vec{m}}{\partial t} = - γ ( \vec{m} \times {\vec{H}}_{eff} ) + α ( \vec{m} \times \frac{\partial \vec{m}}{\partial t} ) - γ {H}_{s} [ \vec{m} \times ( \vec{p} \times \vec{m} ) ] - βγ {H}_{s} ( \vec{m} \times \vec{p} ) \qquad ( 15 )$$

Substituting the right side of Expression (15) as it is into the time differential term of the right side of Expression (15) yields Expression (16).

$$\frac{\partial \vec{m}}{\partial t} = - γ ( \vec{m} \times {\vec{H}}_{eff} ) + α ( \vec{m} \times [ - γ ( \vec{m} \times {\vec{H}}_{eff} ) + α ( \vec{m} \times \frac{\partial \vec{m}}{\partial t} ) - γ {H}_{s} [ \vec{m} \times ( \vec{p} \times \vec{m} ) ] - β γ {H}_{s} ( \vec{m} \times \vec{p} ) ] ) - γ {H}_{s} [ \vec{m} \times ( \vec{p} \times \vec{m} ) ] - β γ {H}_{s} ( \vec{m} \times \vec{p} ) \qquad ( 16 )$$

Rearranging Expression (16) yields Expression (17).

$$\frac{\partial \vec{m}}{\partial t} = - γ ( \vec{m} \times {\vec{H}}_{eff} ) - α γ [ \vec{m} \times ( \vec{m} \times {\vec{H}}_{eff} ) ] + {α}^{2} [ \vec{m} \times ( \vec{m} \times \frac{\partial \vec{m}}{\partial t} ) ] - αγ {H}_{s} [ \vec{m} \times \{ \vec{m} \times ( \vec{p} \times \vec{m} ) \} ] - αβ γ {H}_{s} [ \vec{m} \times ( \vec{m} \times \vec{p} ) ] - γ {H}_{s} [ \vec{m} \times ( \vec{p} \times \vec{m} ) ] - β γ {H}_{s} ( \vec{m} \times \vec{p} ) \qquad ( 17 )$$

Here, Expression (18) holds from the following relation between the constraint expression of the magnetization vector (|m (vector)|=1) and the scalar triple product of the vector.

$$\vec{m} \times ( \vec{m} \times \frac{\partial \vec{m}}{\partial t} ) = - \frac{\partial \vec{m}}{\partial t} , \vec{m} \times \{ \vec{m} \times ( \vec{p} \times \vec{m} ) \} = \vec{m} \times \vec{p} \qquad ( 18 )$$

Substituting Expression (18) into Expression (17) yields Expression (19).

$$\frac{\partial \vec{m}}{\partial t} = - γ ( \vec{m} \times {\vec{H}}_{eff} ) - α γ [ \vec{m} \times ( \vec{m} \times {\vec{H}}_{eff} ) ] - {α}^{2} \frac{\partial \vec{m}}{\partial t} - αγ {H}_{s} ( \vec{m} \times \vec{p} ) - αβ γ {H}_{s} [ \vec{m} \times ( \vec{m} \times \vec{p} ) ] - γ {H}_{s} [ \vec{m} \times ( \vec{p} \times \vec{m} ) ] - β γ {H}_{s} ( \vec{m} \times \vec{p} ) \qquad ( 19 )$$

Rearranging Expression (19) yields Expression (9). This indicates that Expression (15) and Expression (9) are equivalent to each other.

Next, Expression (15) is discretized. Expression (13) is obtained by discretizing Expression (15). Expression (20) is an expression for discretizing Expression (15) by the CN method. However, for a term having a magnetic field which is difficult to be linearized, only the magnetization vector is averaged as illustrated in Expression (21). Specifically, Hₐₙᵢ and H_{exc} are discretized by Expression (20), and H_{d} and Hₐₚₚ are discretized by Expression (21).

Similarly, also for the time differential term, Expression (22), and the term having a triple product, Expression (23), the magnetization vectors are averaged.

$$\begin{matrix}\vec{m} \times \vec{H} = \frac{1}{2} \{ ( {\vec{m}}^{k + 1} \times {\vec{H}}^{k} ) + ( {\vec{m}}^{k} \times {\vec{H}}^{k + 1} ) \} & ( 20 ) \\ \vec{m} \times \vec{H} = ( \frac{{\vec{m}}^{k + 1} + {\vec{m}}^{k}}{2} ) \times {\vec{H}}^{k} & ( 21 ) \\ \vec{m} \times \frac{\partial \vec{m}}{\partial t} = ( \frac{{\vec{m}}^{k + 1} + {\vec{m}}^{k}}{2} ) \times ( \frac{{\vec{m}}^{k + 1} - {\vec{m}}^{k}}{Δ t} ) & ( 22 ) \\ \vec{m} \times ( \vec{p} \times \vec{m} ) = ( \frac{{\vec{m}}^{k + 1} + {\vec{m}}^{k}}{2} ) \times ( {\vec{p}}^{k} \times {\vec{m}}^{k} ) & ( 23 )\end{matrix}$$

Discretizing Expression (15) using Expressions (20, 21, 22, 23) yields Expression (24).

$$\frac{{\vec{m}}^{k + 1} - {\vec{m}}^{k}}{Δ t} = - \frac{γ}{2} \{ [ {\vec{m}}^{k + 1} \times ( {\vec{H}}_{ani}^{k} + {\vec{H}}_{exc}^{k} ) ] + [ {\vec{m}}^{k} \times ( {\vec{H}}_{ani}^{k + 1} + {\vec{H}}_{exc}^{k} ) ] \} + γ [ ( \frac{{\vec{m}}^{k + 1} + {\vec{m}}^{k}}{2} ) \times ( {\vec{H}}_{d}^{k} + {\vec{H}}_{app}^{k} ) ] + α [ ( \frac{{\vec{m}}^{k + 1} + {\vec{m}}^{k}}{2} ) \times ( \frac{{\vec{m}}^{k + 1} - {\vec{m}}^{k}}{Δ t} ) ] - γ {H}_{s}^{k} [ ( \frac{{\vec{m}}^{k + 1} + {\vec{m}}^{k}}{2} ) \times ( {\vec{p}}^{k} \times {\vec{m}}^{k} ) ] - β γ {H}_{s}^{k} [ ( \frac{{\vec{m}}^{k + 1} + {\vec{m}}^{k}}{2} ) \times {\vec{p}}^{k} ] \qquad ( 24 )$$

Rearranging Expression (24) yields Expression (13). By discretizing in this way, it is possible to handle implicitly only terms which may be linearized and to handle nonlinear terms explicitly or partially implicitly. This allows the CN method to be applied to the S-LLG equation.

Next, descriptions are provided for expansion of the S-LLG equation of the spin injection type. Here, the S-LLG equation of the spin injection type is adjusted such that the items of (k+1) are gathered on the left side, and the items of k on the right side. Specifically, Expression (13) is transformed into a form of simultaneous linear equations in the unknown vector m^{k+1}. For each term in Expression (13), terms related to the vector m^{k+1} are transposed to the left side, and the other terms are transposed to the right side. Here, for the terms related to H^{k+1}, these are also functions of the vector m^{k+1}, and thus are transposed to the left side.

$$\frac{{\vec{m}}^{k + 1}}{Δ t} + \frac{γ}{2} \{ [ {\vec{m}}^{k + 1} \times ( {\vec{H}}_{ani}^{k} + {\vec{H}}_{exc}^{k} ) ] + [ {\vec{m}}^{k} \times ( {\vec{H}}_{ani}^{k + 1} + {\vec{H}}_{exc}^{k + 1} ) ] \} + \frac{γ}{2} [ {\vec{m}}^{k + 1} \times ( {\vec{H}}_{d}^{k} + {\vec{H}}_{app}^{k} ) ] - \frac{α}{2 Δ t} [ ( {\vec{m}}^{k + 1} \times {\vec{m}}^{k + 1} ) - 2 ( {\vec{m}}^{k + 1} \times {\vec{m}}^{k} ) ] + \frac{γ {H}_{s}^{k}}{2} [ {\vec{m}}^{k + 1} \times ( {\vec{p}}^{k} \times {\vec{m}}^{k} ) ] + \frac{β γ {H}_{s}^{k}}{2} [ {\vec{m}}^{k + 1} \times {\vec{p}}^{k} ] = \frac{{\vec{m}}^{k}}{Δ t} - \frac{γ}{2} [ {\vec{m}}^{k} \times ( {\vec{H}}_{d}^{k} + {\vec{H}}_{app}^{k} ) ] + \frac{α}{2 Δ t} ( {\vec{m}}^{k} \times {\vec{m}}^{k} ) - \frac{γ {H}_{s}^{k}}{2} [ {\vec{m}}^{k} \times ( {\vec{p}}^{k} \times {\vec{m}}^{k} ) ] - \frac{β γ {H}_{s}^{k}}{2} [ {\vec{m}}^{k} \times {\vec{p}}^{k} ] \\ \vec{m} \times \vec{m} = 0 \qquad ( 25 )$$

Rearranging Expression (25) with the above expression yields Expression (26).

$${\vec{m}}^{k + 1} + \frac{γ Δ t}{2} \{ [ {\vec{m}}^{k + 1} \times ( {\vec{H}}_{ani}^{k} + {\vec{H}}_{exc}^{k} + {\vec{H}}_{d}^{k} + {\vec{H}}_{app}^{k} ) ] + [ {\vec{m}}^{k} \times ( {\vec{H}}_{ani}^{k + 1} + {\vec{H}}_{exc}^{k + 1} ) ] \} + α ( {\vec{m}}^{k + 1} \times {\vec{m}}^{k} ) + \frac{γ Δ {tH}_{s}^{k}}{2} \{ {\vec{m}}^{k + 1} \times [ ( {\vec{p}}^{k} \times {\vec{m}}^{k} ) + β {\vec{p}}^{k} ] \} = {\vec{m}}^{k} - \frac{γ Δ t}{2} [ {\vec{m}}^{k} \times ( {\vec{H}}_{d}^{k} + {\vec{H}}_{app}^{k} ) ] - \frac{γ Δ {tH}_{s}^{k}}{2} \{ {\vec{m}}^{k} \times [ ( {\vec{p}}^{k} \times {\vec{m}}^{k} ) + β {\vec{p}}^{k} ] \} \qquad ( 26 )$$

FIG. 2 illustrates an example of a magnetic material simulation apparatus according to the present embodiment. The magnetic material simulation apparatus 1 includes a static magnetic field potential calculator 2, matrix A calculator 3, matrix B calculator 4, and magnetization vector calculator 5.

From first magnetization vector information and first static magnetic field potential information at a first time on the elements obtained by dividing a magnetic substance into multiple meshes, the static magnetic field potential calculator 2 calculates second static magnetic field potential information on the elements at a second time. The second time is a time later than the first time. An example of the static magnetic field potential calculator 2 is processing at S311 executed by a CPU 12, as described later.

The matrix A calculator 3 calculates a magnetization vector calculation matrix A which is based on the interaction between the meshes at the second time, based on the first magnetization vector information and the second static magnetic field potential information. An example of the matrix A calculator 3 is processing at S312-1 executed by the CPU 12, as described later.

The matrix B calculator 4 calculates a magnetization vector calculation matrix B which is based on the interaction between the meshes at the first time, based on the first magnetization vector information and the second static magnetic field potential information. An example of the matrix B calculator 4 is processing at S312-2 executed by the CPU 12, as described later.

The magnetization vector calculator 5 calculates second magnetization vector information on the elements at the second time, based on the first magnetization vector information, second static magnetic field potential information, magnetization vector calculation matrix A, and magnetization vector calculation matrix B. An example of the magnetization vector calculator 5 is processing at S312-3 executed by the CPU 12, as described later.

The configuration described above improves the calculation speed of the micro magnetic simulation.

The matrix A calculator 3 performs calculation using magnetization vectors at a time earlier than the first time. The configuration described above makes it possible to generate the magnetization vector calculation matrix A and the magnetization vector calculation matrix B, using the present magnetization vector information, the past magnetization vector information, and the present static magnetic field potential information, and thus generate the future magnetization vector information. This improves the calculation accuracy in the micro magnetic simulation.

The static magnetic field potential calculator 2, matrix A calculator 3, matrix B calculator 4, and magnetization vector calculator 5 perform two step processing for one time-integration calculation.

The static magnetic field potential calculator 2 calculates third static magnetic field potential information on the elements at an intermediate time between the first time and the second time, from the first magnetization vector information and the first static magnetic field potential information.

The matrix A calculator 3 calculates a first magnetization vector calculation matrix A which is based on the interaction between the meshes at the intermediate time, based on the first magnetization vector information and the third static magnetic field potential information.

The matrix B calculator 4 calculates a first magnetization vector calculation matrix B which is based on the interaction between the meshes at the intermediate time, based on the first magnetization vector information and the third static magnetic field potential information.

The magnetization vector calculator 5 calculates third magnetization vector information on the elements at the intermediate time, based on the first magnetization vector information, third static magnetic field potential information, magnetization vector calculation matrix A, and magnetization vector calculation matrix B.

The static magnetic field potential calculator 2 calculates the second static magnetic field potential information on the elements at the second time, from the third magnetization vector information and the third static magnetic field potential information.

The matrix A calculator 3 calculates a second magnetization vector calculation matrix A which is based on the interaction between the meshes at the second time, based on the first magnetization vector information, third magnetization vector information, and third static magnetic field potential information.

The matrix B calculator 4 calculates a second magnetization vector calculation matrix B which is based on the interaction between the meshes at the second time, based on the first magnetization vector information, third magnetization vector information, and third static magnetic field potential information.

The magnetization vector calculator 5 calculates the second magnetization vector information on the elements at the second time, based on the first magnetization vector information, third magnetization vector information, second static magnetic field potential information, magnetization vector calculation matrix A, and magnetization vector calculation matrix B.

The configuration described above improves the calculation accuracy in the micro magnetic simulation.

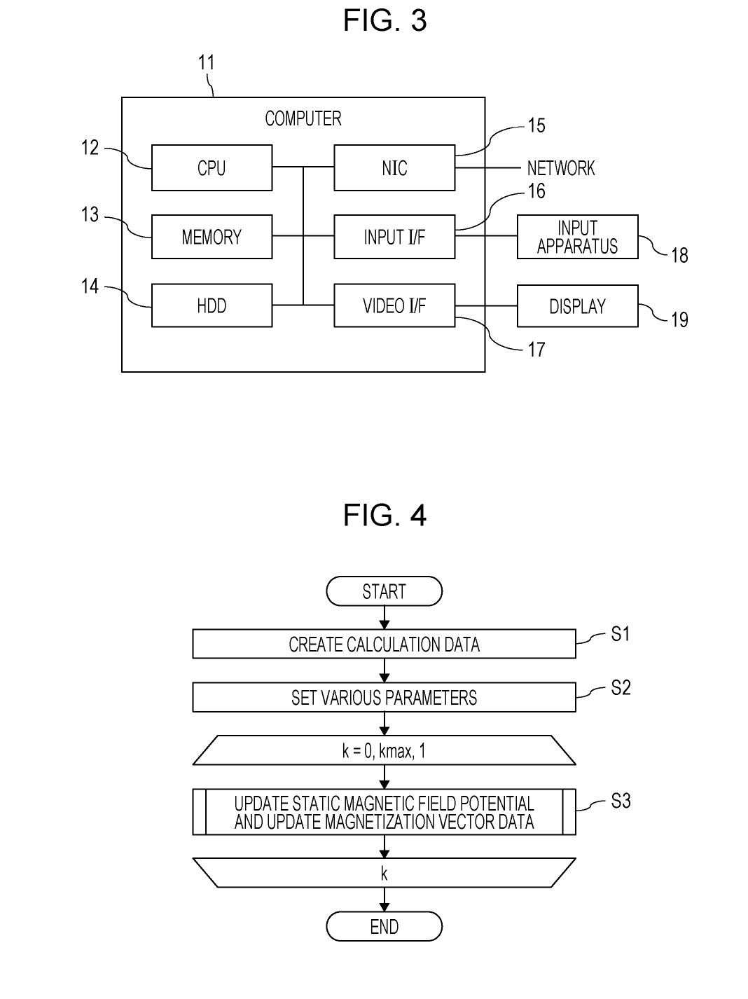

FIG. 3 illustrates an example of the hardware configuration of the magnetic material simulation apparatus. The magnetic material simulation apparatus is, for example, a computer 11. The computer 11 includes a central processing unit (CPU) 12, memory 13, hard disk drive (HDD) 14, network interface card (NIC) 15, input interface 16, and video interface 17. Hereinafter, an interface is called an “I/F”.

The CPU 12 is connected to the memory 13, HDD 14, NIC 15, input I/F 16, and video I/F 17. Connected to the input I/F 16 is an input apparatus 18 such as a keyboard and a mouse. Connected to the video I/F 17 is a display 19.

The CPU 12, an example of a processor, is a central processing unit which controls the overall operation of the computer 11. The memory 13 functions as a working area.

The HDD 14, an example of a mass storage apparatus, is a storage apparatus storing the operating system (OS) and programs for simulation. The NIC 15 is an interface for wired or wireless connection with a communication network such as the Internet or a local area network (LAN).

The input I/F 16 is an interface for transmitting instructions inputted from the input apparatus 18 to the CPU 12. The video I/F 17 is an interface for outputting images to the display 19 on which the calculated results are visually displayed.

The CPU 12 reads and executes programs for the magnetic material simulation stored in the HDD 14. It is assumed that data for the magnetic substance model used for the micromagnetization analysis is stored in the HDD 14 in advance.

FIG. 4 is an example of a flowchart of simulation processing in the present embodiment. The CPU 12 reads the programs for the magnetic material simulation stored in the HDD 14 and executes processing in FIG. 4.

First, the CPU 12 creates data used for calculation (S1). Here, the CPU 12 creates mesh data C, static magnetic field potential data P, and magnetization vector data M, based on information set in advance. Details of the processing at S1 is described later.

Next, the CPU 12 sets various parameters (S2). Here, the CPU 12 sets the initial state of the static magnetic field potential data P, the initial state of the magnetization vector data M, and the maximum number of steps kmax.

Next, the CPU 12 updates the static magnetic field potentials and the magnetization vector data (S3). S3 starts with the initial value of k=0, k being incremented at every execution, and is repeated by loop processing until the value of k reaches kmax. In S3, the magnetization vector data are updated as a measure against (Problem 1). In addition, in S3, an algorithm of the entire time integration is constructed for updating the static magnetic field potentials and the magnetization vector data as a measure against (Problem 2). Details of S3 are described later.

### First Embodiment

In the first embodiment, the static magnetic field is handled explicitly, and for the STT, part of the terms is partially handled implicitly. Concrete discrete equations are described by the foregoing expressions (13, 14).

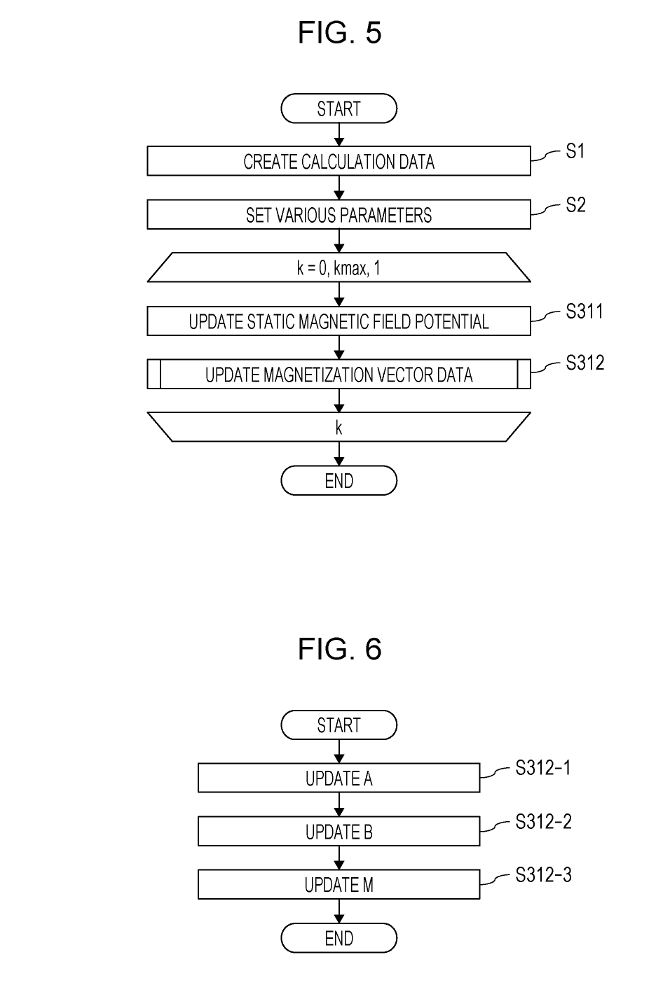

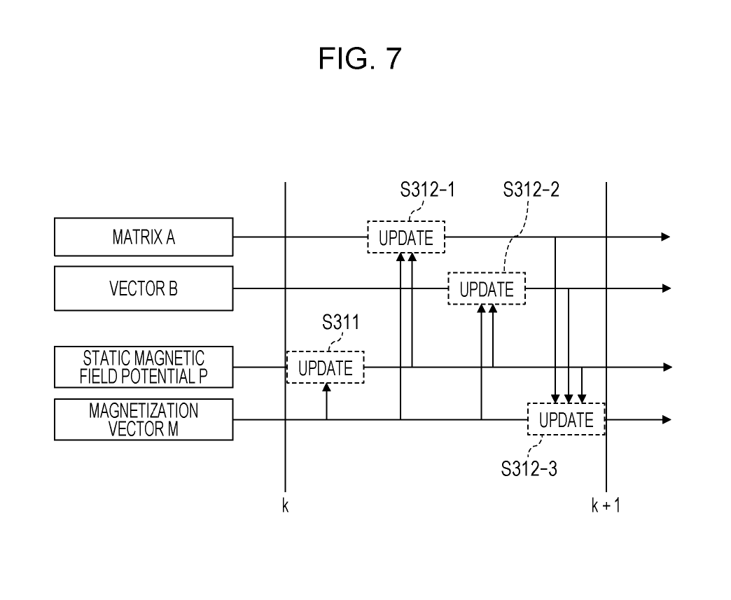

FIG. 5 is an example of a flowchart of the simulation processing. FIG. 6 is an example of a detailed processing procedure for updating the magnetization vector data at S312 in FIG. 5. FIG. 7 is a timing chart illustrating data update timings in the first embodiment. In FIG. 7, the arrows mean reference of data. The start point of each arrow indicates reference of data, and the end point of the arrow indicates update of data.

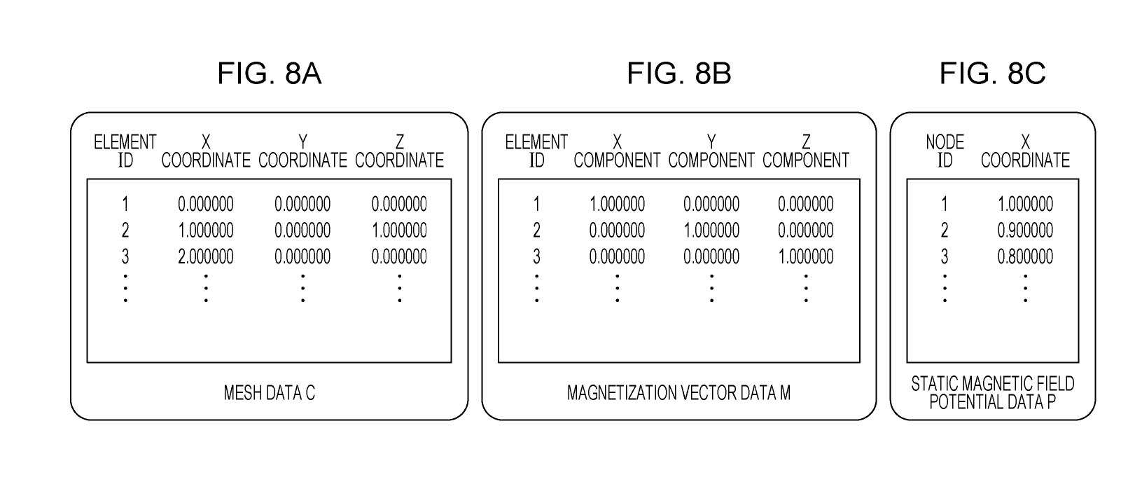

FIGS. 8A, 8B, and 8C are examples of data used in the first embodiment. FIG. 8A illustrates an example of mesh data C. The mesh data C are data including multiple elements in a finite number, into which the area of the magnetic substance to be analyzed is divided by a finite element method or a finite difference method. The element is an area of one of the smallest units into which the area to be analyzed is divided, and is constituted of multiple nodes. In FIG. 8A, the mesh data C are formed of element IDs for distinguishing each element and the coordinates of the element (X coordinate, Y coordinate, Z coordinate).

FIG. 8B illustrates an example of the magnetization vector data M. The magnetization vector data M are formed of the element IDs for distinguishing each element, and the coordinates of the element (X coordinate, Y coordinate, Z coordinate).

FIG. 8C illustrated an example of the static magnetic field potential data P. The static magnetic field potential data P are formed of node IDs of the meshes and X coordinates.

In the first embodiment, Expression (13) or (14) is applied for updating the magnetization vector data at S312 in FIG. 5. Here, Expression (13) is applied as an example.

First, the CPU 12 creates data used for calculation (S1). Here, the CPU 12 creates the mesh data C, static magnetic field potential data P, magnetization vector data M, matrix data A for updating the magnetization vectors, and vector data B for updating the magnetization vectors, based on information set in advance. The matrix data A for updating the magnetization vectors is a matrix for calculating the magnetization vectors, considering the interaction between the magnetization vectors at the (k+1)-th step which is in the future of the k-th step (present). The vector data B for updating the magnetization vectors are a vector for calculating the magnetization vectors, considering the interaction between the magnetization vectors at the present time (k-th step).

Now, creation of the mesh data C is described. When executing the micro magnetic simulation, the CPU 12 adjusts mesh sizes such that the angle formed by magnetization vectors of two adjacent meshes is smaller, to ensure the calculation accuracy.

The CPU 12 extracts information on the distance between adjacent elements, from the mesh data C, combines it with other physical parameters, and stores the resultant information in a predetermined data array. The CPU 12 creates the matrix data A for updating the magnetization vectors and the vector data B for updating the magnetization vectors by calculation from the data array.

Next, the CPU 12 sets various parameters (S2). Here, the CPU 12 sets the initial state of the static magnetic field potential data P. In addition, the CPU 12 sets the initial states of the magnetization vector data M. The CPU 12 initializes with 0s the matrix data A (hereinafter referred to as the “matrix A”) for updating the magnetization vector data. The CPU 12 initializes with 0s the vector data B (hereinafter referred to as the “vector B”) for updating the magnetization vector data. The CPU 12 sets the maximum number of steps kmax.

Next, the CPU 12 updates the static magnetic field potentials P, using the conjugate gradient method (CG method) (S311). The static magnetic field potentials P after update corresponds to the future static magnetic field potentials P. The update at S311 is performed at the timing indicated in FIG. 7.

Next, the CPU 12 updates the magnetization vector data M (S312). Here, the processing by Expression (13) is applied as described above. First, the CPU 12 updates the matrix A and the vector data B for updating the magnetization vectors, using the static magnetic field potential data P updated at S311 and the present magnetization vector data M. The CPU 12 updates the magnetization vector data M, using the updated matrix A and the updated vector data B for updating the magnetization vectors. The updated magnetization vector data M correspond to the future magnetization vector data M. Details of processing at S312 are described using FIG. 6.

After calculating the future M and the future P, the CPU 12 logs out the calculation results, and then calculates the next M and P by loop processing.

FIG. 6 is an example of a detailed processing procedure for updating the magnetization vector data at S312 in FIG. 5. First, the CPU 12 updates the matrix A at the timing indicated in FIG. 7 (S312-1). Here, the matrix A and the vector f are expressed, respectively, by the coefficient matrix A(k,n) on the left side and f(k,n) on the right side of the following Expression (27) obtained by rearranging Expression (13) (Expression (28)).

The CPU 12 calculates A(k,n) in Expression (28), using the static magnetic field potential data P updated at S311 and the present magnetization vector data M, and calculates the matrix A. Using the calculation results, the CPU 12 updates the matrix A.

$$\begin{matrix}[ E + α {A}_{m}^{k} + \frac{γ Δ t}{2} \{ {A}_{H}^{k , n} + {A}_{ani}^{k} + {A}_{exc}^{k} + {A}_{spin}^{n} \} ] {\vec{m}}^{k + l} = [ E - \frac{γ Δ t}{2} \{ {A}_{H}^{n} + {A}_{spin}^{n} \} ] {\vec{m}}^{k} & ( 27 ) \\ A ( k , n ) {\vec{m}}^{k + l} = f ( k , n ) & ( 28 ) \\ l , n = 1 , k & ( 29 )\end{matrix}$$

where E: identity matrix; Aₘ^{k}: coefficient matrix constituted of the components of \vec{m}^{k}; Aₐₙᵢ^{k}: coefficient matrix constituted of the components of \vec{H}ₐₙᵢ^{k}; A_{exc}^{k}: coefficient matrix constituted of the components of \vec{H}_{exc}^{k}; Aₛₚᵢₙⁿ: coefficient matrix constituted of the components of \vec{F}ₛⁿ; A_{N}ⁿ: coefficient matrix constituted of the components of \vec{H}_{d}ⁿ, \vec{H}ₐₚₚⁿ; and A_{B}^{k,n}: coefficient matrix constituted of the components of \vec{H}ₐₙᵢ^{k}, \vec{H}_{exc}^{k}, \vec{H}_{d}ⁿ, \vec{H}ₐₚₚⁿ.

\vec{F}ₛⁿ and Hₛⁿ are expressed as follows:

$$\{ \begin{matrix}{\vec{F}}_{s}^{n} = {H}_{s}^{n} [ ( {\vec{p}}^{n} \times {\vec{m}}^{n} ) + β {\vec{p}}^{n} ] \\ {H}_{s}^{n} = \frac{{p}_{0} hj}{2 {eM}_{s} δ \{ 1 - λ ( {\vec{m}}^{n} - {\vec{p}}^{n} ) \}}\end{matrix} \qquad ( 30 )$$

Next, the CPU 12 updates the vector B at the timing indicated in FIG. 7 (S312-2). Here, the CPU 12 calculates f(k,n) in Expression (28), using the static magnetic field potential data P updated at S311 and the present magnetization vector data M, and calculates the vector B. Using the calculation results, the CPU 12 updates the vector B.

Further, the CPU 12 updates the magnetization vector data M at the timing indicated in FIG. 7 (S312-3). The CPU 12 calculates Expression (28), using the static magnetic field potential data P updated at S311, the present magnetization vector data M, the matrix A updated at S312-1, and the vector B updated at S312-2. Using the calculation results, the CPU 12 updates the magnetization vector data M.

As described above, the CPU 12 creates the matrix A and the vector B, using the present magnetization vector data M and the present static magnetic field potential data P. The CPU 12 creates the future magnetization vector data M, using the matrix A and the vector B which are created as above.

Now, descriptions are provided for a specific example of a method of creating the i-th row of the matrix A and a specific example of a method of creating the i-th element of the vector B.

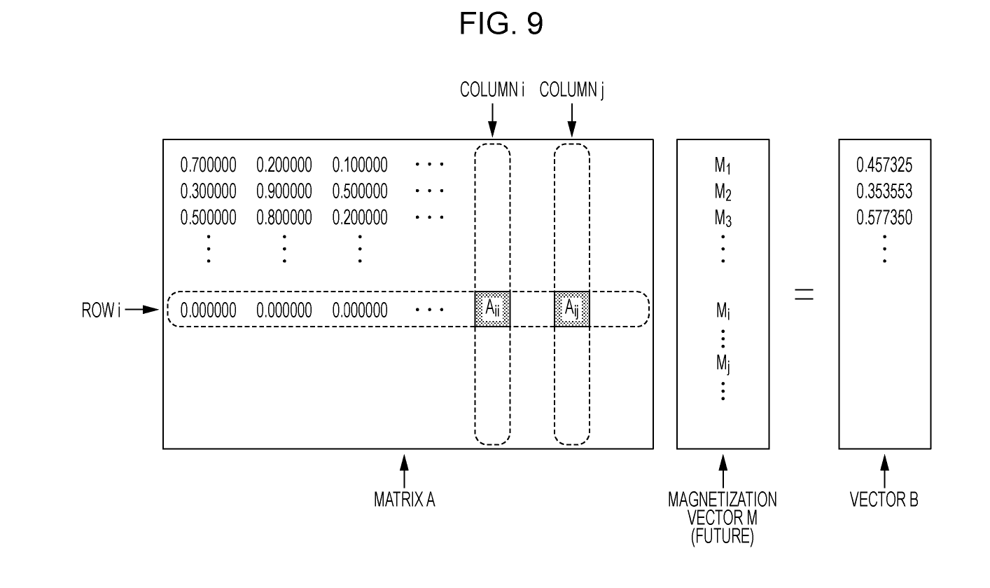

Now the method of creating the i-th row of the matrix A is described. The i-th row of the matrix A corresponds to the relational expression of the i-th component of the future magnetization vector data M (referred to as M_i) (FIG. 9). For example, since the STT term has a relationship only with the own element (M_i) and the adjacent element (referred to as M_j), the matrix A has values at A_ii and A_ij. In other words, if the own element only interacts with the adjacent element, only Aii and Aij have values. The values of the other elements are 0s. Specific values are obtained by calculating Expression (30), and the coefficient for M_i corresponds to A_ii, and the coefficient for M_j corresponds to A_ij.

Next, a method of creating the i-th element of the vector B is described. The vector B is calculated from the right side of Expression (28), using values of the present magnetization vector data M. Specific values of the vector B are calculated from the cross product (Expression (31)) of the magnetization vector data M (present) and Expression (30).

\vec{F}ₛ^{k}×\vec{m}^{k} (31)

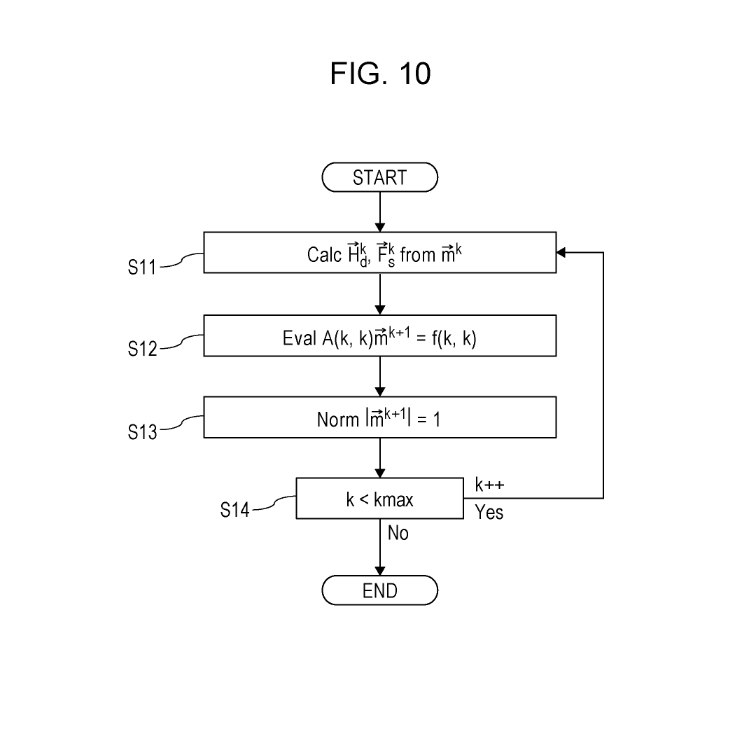

FIG. 10 illustrate a flowchart of time integration in calculation to obtain the oscillation frequency of the spin torque oscillator (STO) in the first embodiment. In FIG. 10, the entire time integration is calculated based on the foregoing Expressions (27) to (30).

Using Expression (30), the CPU 12 calculates the vector H_{d}^{k} and the vector Fₛ^{k} from the vector m^{k} (S11). Using the vector H_{d}^{k} and the vector Fₛ^{k}, the CPU 12 calculates the static magnetic field potential P by the CG method.

Next, the CPU 12 updates the magnetization vector data M from A(k,k) vector m^{k+1}=f(k,k) (S12). Next, the CPU 12 normalizes the vector m^{k+1} (S13).

If k<kmax (“Yes” at S14), the CPU 12 increments k and performs processing at S11. If k≥kmax (“No” at S14), this procedure ends.

### Second Embodiment

In a second embodiment, the intermediate step is evaluated explicitly only for the static magnetic field and the STT term for one time-integration calculation (in other words, calculation is performed two times for one time-integration calculation). Concrete discrete equations are described by Expressions (32, 33, 34, 35).

In the case of discretization of the S-LLG equation of the spin injection type, used for the first calculation (first step) of one time-integration calculation is Expression (32).

$$\frac{{\vec{m}}^{k + \frac{1}{2}} - {\vec{m}}^{k}}{Δ t} = - γ \{ \frac{{\vec{m}}^{k + \frac{1}{2}} \times ( {\vec{H}}_{ani}^{k} + {\vec{H}}_{exc}^{k} )}{2} + \frac{{\vec{m}}^{k} \times ( {\vec{H}}_{ani}^{k + \frac{1}{2}} + {\vec{H}}_{exc}^{k + \frac{1}{2}} )}{2} + \frac{{\vec{m}}^{k + \frac{1}{2}} + {\vec{m}}^{k}}{2} \times ( {\vec{H}}_{d}^{k} + {\vec{H}}_{app}^{k} ) \} + α ( \frac{{\vec{m}}^{k + \frac{1}{2}} + {\vec{m}}^{k}}{2} \times \frac{{\vec{m}}^{k + \frac{1}{2}} - {\vec{m}}^{k}}{Δ t} ) - γ \{ ( \frac{{\vec{m}}^{k + \frac{1}{2}} + {\vec{m}}^{k}}{2} ) \times [ {H}_{s}^{k} ( {\vec{p}}^{k} \times {\vec{m}}^{k} ) ] \} - β γ \{ ( \frac{{\vec{m}}^{k + \frac{1}{2}} + {\vec{m}}^{k}}{2} ) \times [ {H}_{s}^{k} ( {\vec{p}}^{k} \times {\vec{m}}^{k} ) ] \} \qquad ( 32 )$$

Used for the second calculation (second step) of the one time-integration calculation is Expression (33).

$$\frac{{\vec{m}}^{k + 1} - {\vec{m}}^{k}}{Δ t} = - γ \{ \frac{{\vec{m}}^{k + 1} \times ( {\vec{H}}_{ani}^{k} + {\vec{H}}_{exc}^{k} )}{2} + \frac{{\vec{m}}^{k} \times ( {\vec{H}}_{ani}^{k + 1} + {\vec{H}}_{exc}^{k + 1} )}{2} + \frac{{\vec{m}}^{k + 1} + {\vec{m}}^{k}}{2} \times ( {\vec{H}}_{d}^{k + \frac{1}{2}} + {\vec{H}}_{app}^{k + \frac{1}{2}} ) \} + α ( \frac{{\vec{m}}^{k + 1} + {\vec{m}}^{k}}{2} \times \frac{{\vec{m}}^{k + 1} - {\vec{m}}^{k}}{Δ t} ) - γ \{ ( \frac{{\vec{m}}^{k + 1} + {\vec{m}}^{k}}{2} ) \times [ {H}_{s}^{k + \frac{1}{2}} ( {\vec{p}}^{k + \frac{1}{2}} \times {\vec{m}}^{k + \frac{1}{2}} ) ] \} - β γ \{ ( \frac{{\vec{m}}^{k + 1} + {\vec{m}}^{k}}{2} ) \times [ {H}_{s}^{k + \frac{1}{2}} ( {\vec{p}}^{k + \frac{1}{2}} \times {\vec{m}}^{k + \frac{1}{2}} ) ] \} \qquad ( 33 )$$

In the case of discretization of the S-LLG equation of the domain wall displacement type, used for the first calculation (first step) of one time-integration calculation is Expression (34).

$$\frac{{\vec{m}}^{k + \frac{1}{2}} - {\vec{m}}^{k}}{Δ t} = - γ \{ \frac{{\vec{m}}^{k + \frac{1}{2}} \times ( {\vec{H}}_{ani}^{k} + {\vec{H}}_{exc}^{k} )}{2} + \frac{{\vec{m}}^{k} \times ( {\vec{H}}_{ani}^{k + \frac{1}{2}} + {\vec{H}}_{exc}^{k + \frac{1}{2}} )}{2} + \frac{{\vec{m}}^{k + \frac{1}{2}} + {\vec{m}}^{k}}{2} \times ( {\vec{H}}_{d}^{k} + {\vec{H}}_{app}^{k} ) \} + α ( \frac{{\vec{m}}^{k + \frac{1}{2}} + {\vec{m}}^{k}}{2} \times \frac{{\vec{m}}^{k + \frac{1}{2}} - {\vec{m}}^{k}}{Δ t} ) - ( {\vec{u}}^{′} \cdot ▽ ) \frac{{\vec{m}}^{k + \frac{1}{2}} + {\vec{m}}^{k}}{2} + β [ {\vec{m}}^{k} \times ( {\vec{u}}^{k} \cdot ▽ ) \frac{{\vec{m}}^{k + \frac{1}{2}} + {\vec{m}}^{k}}{2} ] \qquad ( 34 )$$

Used for the second calculation (second step) of the one time-integration calculation is Expression (35).

$$\frac{{\vec{m}}^{k + 1} - {\vec{m}}^{k}}{Δ t} = - γ \{ \frac{{\vec{m}}^{k + 1} \times ( {\vec{H}}_{ani}^{k} + {\vec{H}}_{exc}^{k} )}{2} + \frac{{\vec{m}}^{k} \times ( {\vec{H}}_{ani}^{k + 1} + {\vec{H}}_{exc}^{k + 1} )}{2} + \frac{{\vec{m}}^{k + 1} + {\vec{m}}^{k}}{2} \times ( {\vec{H}}_{d}^{k + \frac{1}{2}} + {\vec{H}}_{app}^{k + \frac{1}{2}} ) \} + α ( \frac{{\vec{m}}^{k + 1} + {\vec{m}}^{k}}{2} \times \frac{{\vec{m}}^{k + 1} - {\vec{m}}^{k}}{Δ t} ) - ( {\vec{u}}^{k + \frac{1}{2}} \cdot ▽ ) \frac{{\vec{m}}^{k + 1} + {\vec{m}}^{k}}{2} + β [ {\vec{m}}^{k + \frac{1}{2}} \times ( {\vec{u}}^{k + \frac{1}{2}} \cdot ▽ ) \frac{{\vec{m}}^{k + 1} + {\vec{m}}^{k}}{2} ] \qquad ( 35 )$$

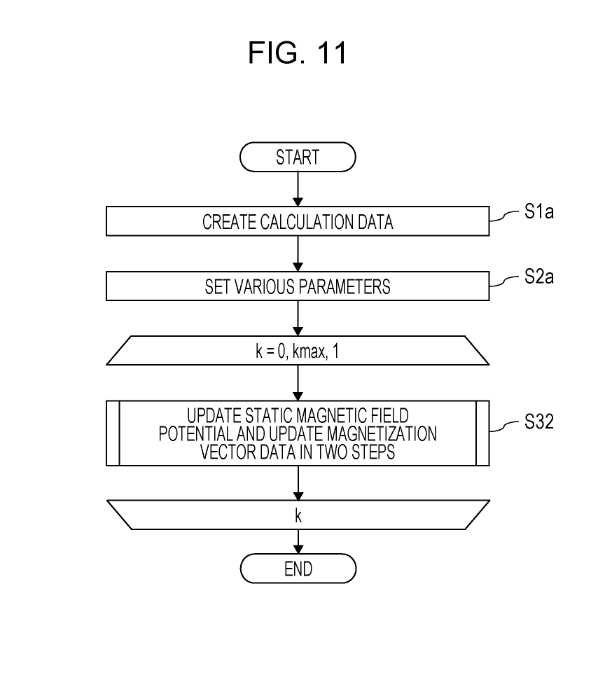

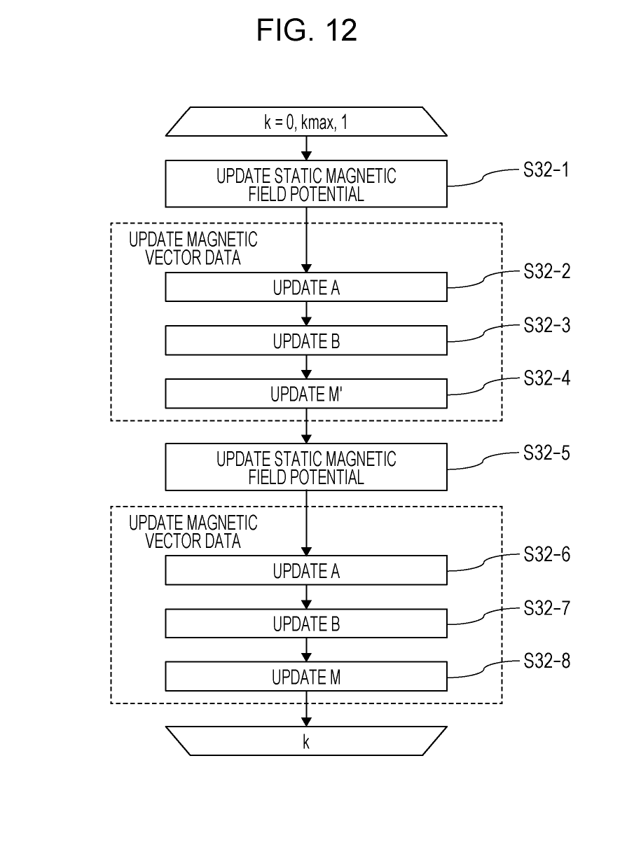

FIG. 11 is an example of a flowchart of simulation processing in the second embodiment. FIG. 12 is an example of detailed processing procedure for updating static magnetic field potentials and magnetization vector data in two steps at S32 in FIG. 11. In the second embodiment, the present magnetization vector data M, past magnetization vector data M, and present static magnetic field potential data P are used to create the matrix A and the vector B. Then, the matrix A and the vector B are used to create the future magnetization vector data M. This process improves the accuracy. The second embodiment is different from the first embodiment in that the values of the past magnetization vector data M are held.

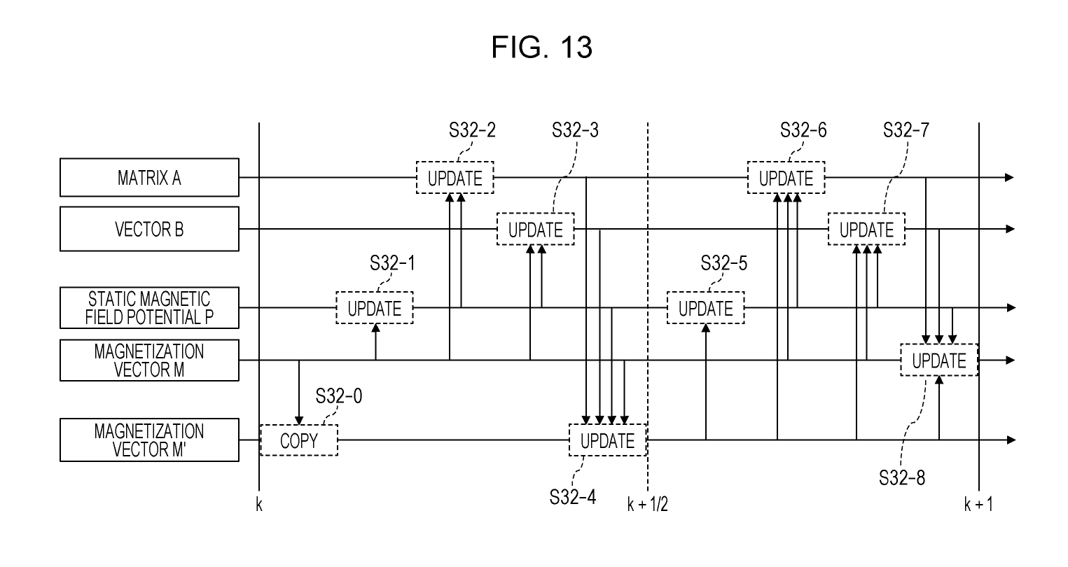

FIG. 13 is a timing chart illustrating data update timings in the second embodiment. In FIG. 13, the arrows mean reference of data. The start point of each arrow indicates reference of data, and the end point of the arrow indicates update of data.

In the second embodiment, Expressions (32) and (33) or Expressions (34) and (35) may be applied for updating the static magnetic field potentials and the magnetization vector data in two steps at S32 in FIG. 11. Here, Expressions (32) and (33) are applied as an example. Note that in the second embodiment, the constituents denoted by the same signs or symbols as in the first embodiment are the same as those in the first embodiment, and descriptions thereof are omitted.

In addition, in the second embodiment, the following Condition (36) is applied to the foregoing Expression (28).

$$l , n = \{ \begin{matrix}\frac{1}{2} , k & for the first step \\ 1 , k + \frac{1}{2} & for the second step\end{matrix} \qquad ( 36 )$$

First, the CPU 12 creates data used for calculation (S1a). Here, the CPU 12 creates the mesh data C, static magnetic field potential data P, magnetization vector data M, matrix data A for updating the magnetization vectors, and vector data B for updating the magnetization vectors, based on information set in advance. The CPU 12 further creates vector data M′ for updating the magnetization vectors. The vector data M′ for updating the magnetization vectors are data which are copies of the contents of the magnetization vector data M before update at step k (present) in the update processing of the vector data M for updating the magnetization vectors.

Next, the CPU 12 sets various parameters (S2). Here, the CPU 12 sets the initial state of the static magnetic field potential data P. In addition, the CPU 12 sets the initial state of the magnetization vector data M. The CPU 12 initializes the matrix A with 0s. The CPU 12 initializes the matrix B with 0s. The CPU 12 initializes with 0s the vector data M′ for updating the magnetization vectors. The CPU 12 sets the maximum number of steps kmax.

Next, the CPU 12 updates the static magnetic field potentials and the magnetization vector data in two steps (S32). Details of processing at S32 are described using FIG. 12. S32 starts with the initial value of k=0, k being incremented at every execution, and is repeated by loop processing until the value of k reaches kmax.

Hereinafter, descriptions are provided with reference to FIGS. 12 and 13. The CPU 12 copies the magnetization vector data M into the vector data M′ for updating the magnetization vectors at the timing indicated with S32-0 in FIG. 13.

Using the magnetization vector data M, the CPU 12 updates the static magnetic field potentials P based on the CG method at the timing indicated in FIG. 13 (S32-1).

Next, the CPU 12 updates the matrix A at the timing indicated in FIG. 13 (S32-2). Here, the CPU 12 calculates A(k,n) in Expression (28) using the static magnetic field potential data P updated at S32-1 and the magnetization vector data M, and calculates the matrix A. Here, Condition (36) for the first step is applied. Using the calculation results, the CPU 12 updates the matrix A.

Next, the CPU 12 updates the vector B at the timing indicated in FIG. 13 (S32-3). Here, the CPU 12 calculates f(k,n) in Expression (28) using the static magnetic field potential data P updated at S32-1 and the magnetization vector data M, and calculates the vector B. Here, Condition (36) for the first step is applied. Using the calculation results, the CPU 12 updates the vector B.

Further, the CPU 12 updates the vector data M′ for updating the magnetization vectors at the timing indicated in FIG. 13 (S32-4). CPU 12 calculates Expression (28) using the static magnetic field potential data P updated at S32-1, the magnetization vector data M, the matrix A updated at S32-2, and the vector B updated at S32-3. Here, Condition (36) for the first step is applied. Using the calculation results, the CPU 12 updates the vector data M′ for updating the magnetization vectors.

Next, using the magnetization vector data M′, the CPU 12 updates the static magnetic field potentials P based on the CG method at the timing indicated in FIG. 13 (S32-5).

Next, the CPU 12 updates the matrix A at the timing indicated in FIG. 13 (S32-6). Here, the CPU 12 calculates A(k,n) in Expression (28) using the static magnetic field potential data P updated at S32-5, the magnetization vector data M, and the vector data M′ for updating the magnetization vectors, and calculates the matrix A. Here, Condition (36) for the second step is applied. Using the calculation results, the CPU 12 updates the matrix A.

Next, the CPU 12 updates the vector B at the timing indicated in FIG. 13 (S32-7). Here, the CPU 12 calculates f(k,n) in Expression (28) using the static magnetic field potential data P updated at S32-6, the magnetization vector data M, and the vector data M′ for updating the magnetization vectors, and calculates the vector B. Here, Condition (36) for the second step is applied. Using the calculation results, the CPU 12 updates the vector B.

Further, the CPU 12 updates the magnetization vector data M′ at the timing indicated in FIG. 13 (S32-8). The CPU 12 calculates Expression (28) using the updated static magnetic field potential data P, the magnetization vector data M, the updated vector data M′ for updating the magnetization vectors, the updated matrix A, and the updated vector B. Here, Condition (36) for the second step is applied. Using the calculation results, the CPU 12 updates the magnetization vector data M.

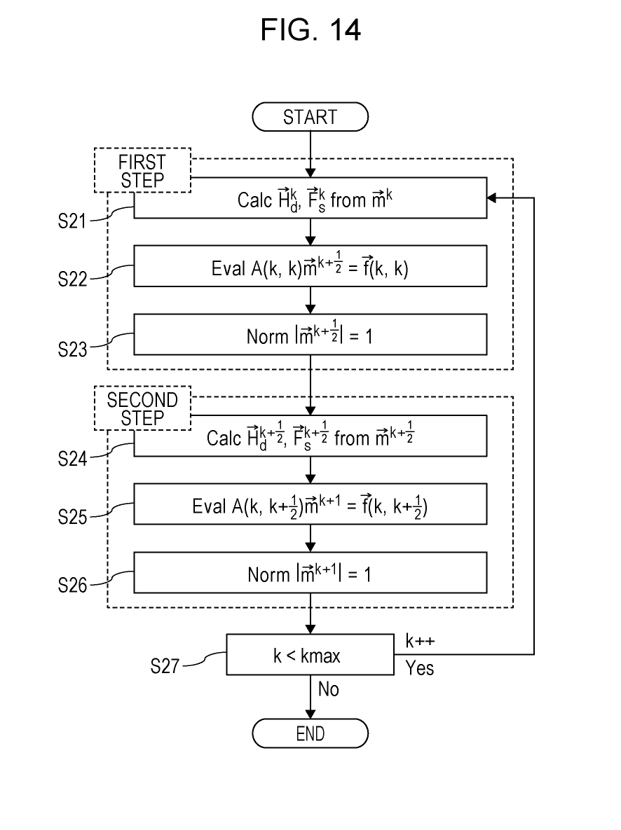

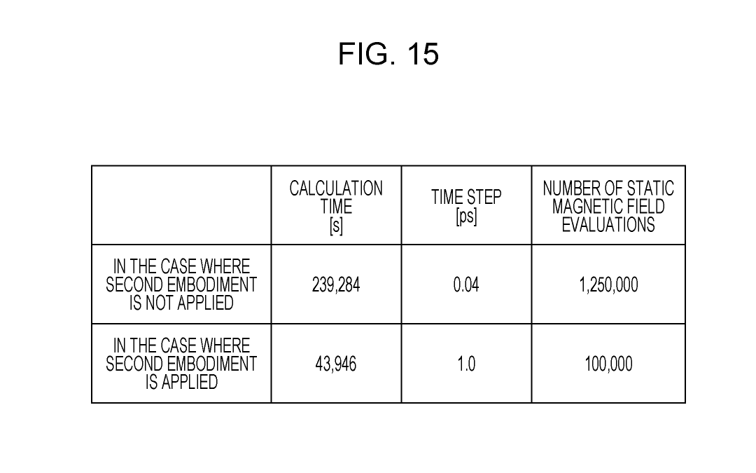

FIG. 14 illustrates a flowchart of time integration in calculation for obtaining the oscillation frequency of the spin torque oscillator (STO) in the second embodiment. In FIG. 14, the CPU 12 calculates the entire time integration based on the foregoing Expressions (27), (28), (36), and (30).

First, the processing for the first step is performed. The CPU 12 calculates vector H_{d}^{k} and vector Fₛ^{k} from vector m^{k} using Expression (30) (S21). Using vector H_{d}^{k} and vector Fₛ^{k}, the CPU 12 calculates the static magnetic field potentials P using the CG method.

Next, the CPU 12 updates the magnetization vector data M from A(k,k) vector m^{k+1/2}=f(k,k) (S22). Next, the CPU 12 normalizes vector m^{k+1/2} (S23).

Next, the processing for the second step is performed. Using Expression (30), the CPU 12 calculates vector H_{d}^{k+1/2} and vector Fₛ^{k+1/2} from vector m^{k+1/2} (S24). The CPU 12 calculates the static magnetic field potentials P by the CG method using vector H_{d}^{k+1/2} and vector Fₛ^{k+1/2}.

Next, the CPU 12 updates the magnetization vector data M from A(k,k+1/2) vector m^{k+1}=f(k,k+1/2) (S25). Next, the CPU 12 normalizes vector m^{k+1/2} (S26).

If k<kmax (“Yes” at S27), the CPU 12 increments k and performs the processing at S21. If k≥kmax (“No” at S27), this procedure ends.

FIG. 15 is a table for confirming the increase in speed of calculation for obtaining the oscillation frequency of the STO in the second embodiment. FIG. 15 indicates times taken to perform calculation of 50 [ns] (simulation time) for the case of using the second embodiment and the case of not using it. It is seen that applying the second embodiment reduces the calculation time to one-fifth (≈43.946/239.284).

The first embodiment makes it possible to apply the CN method to the MS (a hybrid CN method). In other words, the first embodiment exerts the MS function by the hybrid CN method which handles implicitly only terms which may be linearized, and handles nonlinear terms explicitly or partially implicitly. The CN method is a semi-implicit method in which it is possible to take averages between future values and past values and handle them partially implicitly.

The second embodiment improves the accuracy of nonlinear terms in the hybrid CN method. In other words, in the second embodiment, an intermediate point is evaluated in the time integration, and the time integration may be performed considering the intermediate point only for nonlinear terms.

Note that the present disclosure is not limited to the embodiments described above, and may take various forms of configurations or embodiments without departing from the gist of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a magnetic material simulation program that causes a computer to execute a process, the process comprising:
calculating, from first magnetization vector information at a first time on elements obtained by dividing a magnetic substance into a plurality of meshes, first static magnetic field potential information of the elements at the first time;
calculating a magnetization vector calculation matrix A which is based on interaction between the meshes at a second time, by using the first magnetization vector information and the first static magnetic field potential information;
calculating a magnetization vector calculation matrix B which is based on interaction between the meshes at the first time, by using the first magnetization vector information and the first static magnetic field potential information; and
calculating second magnetization vector information on the elements at the second time, by using the first magnetization vector information, the first static magnetic field potential information, the magnetization vector calculation matrix A, and the magnetization vector calculation matrix B.

2. The storage medium according to claim 1, wherein
in the calculating the magnetization vector calculation matrix A, magnetization vectors at a time earlier than the first time are used.

3. The storage medium according to claim 1, wherein one time-integration calculation comprises:
calculating the first static magnetic field potential information of the elements at the first time, from the first magnetization vector information;
calculating a first magnetization vector calculation matrix A which is based on interaction between the meshes at an intermediate time between the first time and the second time, by using the first magnetization vector information and the first static magnetic field potential information;
calculating a first magnetization vector calculation matrix B which is based on the interaction between the meshes at the intermediate time, by using the first magnetization vector information and the first static magnetic field potential information;
calculating third magnetization vector information on the elements at the intermediate time, by using the first magnetization vector information, the first static magnetic field potential information, the magnetization vector calculation matrix A, and the magnetization vector calculation matrix B;
calculating a third static magnetic field potential information on the elements at the intermediate time, from the third magnetization vector information;
calculating a second magnetization vector calculation matrix A which is based on the interaction between the meshes at the second time, by using the first magnetization vector information, the third magnetization vector information, and the third static magnetic field potential information;
calculating a second magnetization vector calculation matrix B which is based on the interaction between the meshes at the first time, based on the first magnetization vector information, the third magnetization vector information, and the third static magnetic field potential information; and
calculating the second magnetization vector information on the elements at the second time, based on the first magnetization vector information, the third magnetization vector information, the third static magnetic field potential information, the magnetization vector calculation matrix A, and the magnetization vector calculation matrix B.

4. A magnetic material simulation apparatus comprising:
a memory, and
a processor coupled to the memory and configured to execute a process, the process comprising:
calculating, from first magnetization vector information at a first time on elements obtained by dividing a magnetic substance into a plurality of meshes, first static magnetic field potential information of the elements at the first time;
calculating a magnetization vector calculation matrix A which is based on interaction between the meshes at a second time, by using the first magnetization vector information and the first static magnetic field potential information;
calculating a magnetization vector calculation matrix B which is based on interaction between the meshes at the first time, by using the first magnetization vector information and the first static magnetic field potential information; and
calculating second magnetization vector information on the elements at the second time, by using the first magnetization vector information, the first static magnetic field potential information, the magnetization vector calculation matrix A, and the magnetization vector calculation matrix B.

5. The magnetic material simulation apparatus according to claim 4,
wherein in the calculating the magnetization vector calculation matrix A, magnetization vectors at a time earlier than the first time are used.

6. The magnetic material simulation apparatus according to claim 4, wherein one time-integration calculation comprises:
calculating the first static magnetic field potential information of the elements at the first time, from the first magnetization vector information;
calculating a first magnetization vector calculation matrix A which is based on interaction between the meshes at an intermediate time between the first time and the second time, by using the first magnetization vector information and the first static magnetic field potential information;
calculating a first magnetization vector calculation matrix B which is based on the interaction between the meshes at the intermediate time, by using the first magnetization vector information and the first static magnetic field potential information;
calculating third magnetization vector information on the elements at the intermediate time, by using the first magnetization vector information, the first static magnetic field potential information, the magnetization vector calculation matrix A, and the magnetization vector calculation matrix B;
calculating a third static magnetic field potential information on the elements at the intermediate time, from the third magnetization vector information;
calculating a second magnetization vector calculation matrix A which is based on the interaction between the meshes at the second time, by using the first magnetization vector information, the third magnetization vector information, and the third static magnetic field potential information;
calculating a second magnetization vector calculation matrix B which is based on the interaction between the meshes at the first time, based on the first magnetization vector information, the third magnetization vector information, and the third static magnetic field potential information; and
calculating the second magnetization vector information on the elements at the second time, based on the first magnetization vector information, the third magnetization vector information, the third static magnetic field potential information, the magnetization vector calculation matrix A, and the magnetization vector calculation matrix B.

7. A magnetic material simulation method for a computer to execute a process, the process comprising:
calculating, from first magnetization vector information at a first time on elements obtained by dividing a magnetic substance into a plurality of meshes, first static magnetic field potential information of the elements at the first time;
calculating a magnetization vector calculation matrix A which is based on interaction between the meshes at a second time, by using the first magnetization vector information and the first static magnetic field potential information;
calculating a magnetization vector calculation matrix B which is based on interaction between the meshes at the first time, by using the first magnetization vector information and the first static magnetic field potential information; and
calculating second magnetization vector information on the elements at the second time, by using the first magnetization vector information, the first static magnetic field potential information, the magnetization vector calculation matrix A, and the magnetization vector calculation matrix B.

8. The magnetic material simulation method according to claim 7,
wherein in the calculating the magnetization vector calculation matrix A, magnetization vectors at a time earlier than the first time are used.

9. The magnetic material simulation method according to claim 7, wherein one time-integration calculation comprises:
calculating the first static magnetic field potential information of the elements at the first time, from the first magnetization vector information;
calculating a first magnetization vector calculation matrix A which is based on interaction between the meshes at an intermediate time between the first time and the second time, by using the first magnetization vector information and the first static magnetic field potential information;
calculating a first magnetization vector calculation matrix B which is based on the interaction between the meshes at the intermediate time, by using the first magnetization vector information and the first static magnetic field potential information;
calculating third magnetization vector information on the elements at the intermediate time, by using the first magnetization vector information, the first static magnetic field potential information, the magnetization vector calculation matrix A, and the magnetization vector calculation matrix B;
calculating a third static magnetic field potential information on the elements at the intermediate time, from the third magnetization vector information;
calculating a second magnetization vector calculation matrix A which is based on the interaction between the meshes at the second time, by using the first magnetization vector information, the third magnetization vector information, and the third static magnetic field potential information;
calculating a second magnetization vector calculation matrix B which is based on the interaction between the meshes at the first time, based on the first magnetization vector information, the third magnetization vector information, and the third static magnetic field potential information; and
calculating the second magnetization vector information on the elements at the second time, based on the first magnetization vector information, the third magnetization vector information, the third static magnetic field potential information, the magnetization vector calculation matrix A, and the magnetization vector calculation matrix B.

10. A non-transitory computer-readable storage medium storing a magnetic material simulation program that causes a computer to execute a process, the process comprising:
dividing a magnetic substance into a plurality of meshes, each of the plurality of meshes comprising a plurality of elements;
calculating, from first magnetization vector information at a first time on the elements, first static magnetic field potential information of the elements at the first time;
calculating a magnetization vector calculation matrix A which is based on interaction between the meshes at a second time, by using the first magnetization vector information and the first static magnetic field potential information;
calculating a magnetization vector calculation matrix B which is based on interaction between the meshes at the first time, by using the first magnetization vector information and the first static magnetic field potential information;
calculating second magnetization vector information on the elements at the second time, by using the first magnetization vector information, the first static magnetic field potential information, the magnetization vector calculation matrix A, and the magnetization vector calculation matrix B; and
analyzing magnetic domain states of the magnetic substance based on the first magnetization vector information and the second magnetization vector information.

11. The non-transitory computer-readable storage medium of claim 1, wherein the magnetic substance is a micro magnetic device.
